(19) United States
(12) Patent Application Publication
(10) Pub. No.: US 2024/0326877 A1
(43) Pub. Date: Oct. 3, 2024

(54) CONTROL DEVICE FOR VEHICLE, VEHICLE CONTROL METHOD, AND NONTRANSITORY COMPUTER RECORDING MEDIUM

(71) Applicants: TOYOTA JIDOSHA KABUSHIKI KAISHA, Toyota-shi (JP); AISIN CORPORATION, Kariya (JP)

(72) Inventors: Kenta YAMADA, Shinagawa-ku (JP); Hiroshi MORIMOTO, Ota-ku (JP); Takuhiro OMI, Anjo-shi (JP); Udara Eshan MANAWADU, Edogawa-ku (JP)

(73) Assignees: TOYOTA JIDOSHA KABUSHIKI KAISHA, Toyota-shi (JP); AISIN CORPORATION, Kariya (JP)

(21) Appl. No.: 18/591,299

(22) Filed: Feb. 29, 2024

(30) Foreign Application Priority Data
Mar. 31, 2023 (JP) 2023-058710

(51) Int. Cl. B60W 60/00; G09B 9/04

(52) U.S. Cl. CPC B60W 60/0055; B60W 60/0057; G09B 9/04

(57) ABSTRACT

A control device is configured to: perform automated driving for automatically performing driving operations of the vehicle; make a driver practice taking back driving from automated driving to manual driving, where at least part of the driving tasks are performed by the driver, during automated driving and calculate proficiency level of taking back driving based on one or both of a time period required for taking back driving when practicing taking back driving and action of the driver in the period for taking back driving; identify a current driving scene based on surrounding data showing a state of the surroundings of the vehicle; and practice taking back driving by a frequency in accordance with the proficiency level calculated when last practicing taking back driving in the same driving scene as the present.

### FIELD

The present invention relates to a control device for a vehicle, a vehicle control method, and a nontransitory computer recording medium.

### BACKGROUND

Japanese Patent No. 6733293 discloses a conventional automated driving system which, when performing automated driving, makes a driver practice taking back driving from automated driving and resuming manual driving.

### SUMMARY

However, the above-mentioned conventional automated driving system had been configured to make a driver practice taking back driving at the time of a driving scene suitable for practicing taking back driving such as a driving scene in which there is no other vehicle present in the surroundings of a host vehicle and it is projected that driving at a set speed can be continued for a certain time period.

A request for taking back driving from automated driving and resuming manual driving could be output to the driver from the automated driving system in various driving scenes and would not necessarily be limited to being output in driving scenes suitable for taking back driving. For this reason, in the above-mentioned conventional automated driving system, a request for taking back driving is liable to be output in a driving scene in which taking back driving has not been practiced. As a result, depending on the driving scene, it is liable to not be possible to quickly take back driving.

The present invention was made focusing on such a problem and has as its object to make a driver practice taking back driving in various driving scenes at a suitably frequency.

The gist of the present disclosure is as follows:

(1) A control device of a vehicle, which control device of a vehicle configured to: perform automated driving for automatically performing driving operations of the vehicle; make a driver practice taking back driving from automated driving and resuming manual driving, where at least part of the driving tasks are performed by the driver, during automated driving and calculate a proficiency level of taking back driving based on one or both of a time period required for taking back driving when practicing taking back driving and action of the driver in the period for taking back driving; identify a current driving scene based on surrounding data showing a state of the surroundings of the vehicle; and practice taking back driving by a frequency in accordance with the proficiency level calculated when last practicing taking back driving in the same driving scene as the present.

(2) The control device of a vehicle according to the above (1) configured to reduce the frequency when the proficiency level is high compared to when it is low.

(3) The control device of a vehicle according to the above (1), configured to: set a practice interval based on the proficiency level calculated when last practicing taking back driving at the same driving scene as the present; and practice taking back driving if an elapsed time from when last practicing taking back driving at the same driving scene as the present is greater than or equal to the practice interval.

(4) The control device of a vehicle according to the above (3), configured to lengthen the practice interval when the proficiency level is high compared to when it is low.

(5) The control device of a vehicle according to any one of the above (1) to the above (4), configured to: perform correction so as to lower the proficiency level based on the elapsed time from when last practicing taking back driving at the same driving scene as the present; and increase an amount of correction gradually or in stages as the elapsed time becomes longer.

(6) The control device of a vehicle according to any one of the above (1) to the above (4), configured to raise the proficiency level when the time period required for taking back driving is short compared to when it is long.

(7) The control device of a vehicle according to any one of the above (1) to the above (4), configured to compare actions of the driver in the period for taking back driving with evaluation items set for each driving scene and raise the proficiency level when there are many actions which match the evaluation items compared with when there are few.

(8) The control device of a vehicle according to the above (7), wherein the evaluation items include any presence of safety check operations set in advance for each driving scene and timing of performance.

(9) The control device of a vehicle according to the above (7), wherein evaluation items include an amount of operation in a driving operation in the period for taking back driving not exceeding the allowable amount set in advance for each driving scene.

(10) The control device of a vehicle according to any one of the above (1) to the above (4), configured to: identify a second task which the driver is performing during automated driving based on driver data showing the state of the driver; and separately practice taking back driving by a frequency corresponding to the proficiency level calculated at the time of most recently practicing taking back driving when performing the same second task as the present.

(11) The control device of a vehicle according to the above (10), configured to: set the practice interval based on the proficiency level calculated at the time of most recently practicing taking back driving when performing the same second task as the present; and separately practice taking back driving if the elapsed time from most recently practicing taking back driving when performing the same second task as the present is greater than or equal to the practice interval.

(12) The control device of a vehicle according to any one of the above (1) to the above (4), which notifies the driver of an evaluation of practicing taking back driving through an output device making notifications to the driver of the vehicle when finishing practicing taking back driving.

(13) A vehicle control method by a control device, the vehicle control method by a control device comprising: performing automated driving for automatically performing driving operations of the vehicle; making a driver practice taking back driving from automated driving and resuming manual driving, where at least part of the driving tasks are performed by the driver, during automated driving and calculating a proficiency level of taking back driving based on one or both of a time period required for taking back driving when practicing taking back driving and action of the driver in the period for taking back driving; identifying a current driving scene based on surrounding data showing a state of the surroundings of the vehicle; and practicing taking back driving by a frequency in accordance with the proficiency level calculated when last practicing taking back driving in the same driving scene as the present.

(14) A nontransitory computer recording medium including a computer program for a control device of a vehicle, the nontransitory computer recording medium including a computer program for making the control device: perform automated driving for automatically performing driving operations of the vehicle; during automated driving, make a driver practice taking back driving from automated driving and resuming manual driving, where at least part of the driving tasks are performed by the driver, and calculate a proficiency level of taking back driving based on one or both of a time period required for taking back driving when practicing taking back driving and action of the driver in the period for taking back driving; identify a current driving scene based on surrounding data showing a state of the surroundings of the vehicle; and practice taking back driving by a frequency in accordance with the proficiency level calculated when last practicing taking back driving in the same driving scene as the present.

According to these aspects of the present invention, it possible to make a driver practice taking back driving in various driving scenes at a suitably frequency.

### BRIEF DESCRIPTION OF DRAWINGS

FIG. 1 is a schematic system diagram of a vehicle according to a first embodiment of the present invention.

FIG. 2 is a view showing a hardware configuration of a control device.

FIG. 3 is a flow chart for explaining details of processing for practicing taking back driving according to the first embodiment of the present invention.

FIG. 4 is a flow chart for explaining details of processing for practicing taking back driving according to a second embodiment of the present invention.

### DESCRIPTION OF EMBODIMENTS

Below, embodiments of the present invention will be explained in detail with reference to the drawings. Note that in the following explanation, similar component elements will be assigned the same reference notations.

### First Embodiment

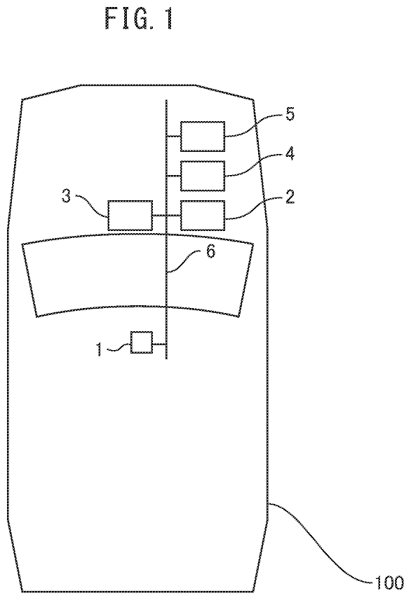

FIG. 1 is a schematic system view of a vehicle 100 according to a first embodiment of the present invention.

The vehicle 100 is provided with a surrounding sensor 1, driver sensor 2, output device 3, storage device 4, and control device 5. The surrounding sensor 1, driver sensor 2, output device 3, storage device 4, and control device 5 are connected to be able to communicate through an internal vehicle network 6 based on the standard called a “Controller Area Network”.

The surrounding sensor 1 is a sensor for generating surrounding data showing the state of the surroundings of the vehicle 100. In the present embodiment, as the surrounding sensor 1, one or more external cameras for capturing the surrounding of the vehicle 100 are provided. An external camera captures the surroundings of the vehicle 100 by a predetermined frame rate (for example, 10 Hz to 40 Hz) and generates surrounding images in which the surroundings of the vehicle 100 are reflected. The external camera sends the generated surrounding images as surrounding data to the control device 5 each time generating surrounding images.

Note that instead of an external camera or in addition to an external camera, it is also possible to provide as a surrounding sensor 1 a distance measurement sensor for measuring the distance up to another vehicle or pedestrian etc. present in the surroundings of the vehicle 100. As an example of a distance measurement sensor, for example, a lidar (light detection and ranging device) for emitting laser light and measuring distance based on its reflected light, a millimeter wave radar sensor for emitting an electromagnetic wave and measuring distance based on its reflected wave, etc. may be mentioned.

The driver sensor 2 is a sensor for generating driver data showing the state of a driver. In the present embodiment, as the driver sensor 2, a driver monitor camera is provided for capturing the appearance of the driver including the face of the driver. The driver monitor camera captures the appearance of the driver by a predetermined frame rate (for example, 10 Hz to 40 Hz) and generates external images in which the appearance of the driver is reflected. The driver monitor camera sends the generated external images as driver data to the control device 5 each time generating external images of the driver.

The output device 3 is a device for notifying information to a driver through physical senses of the driver of the vehicle 100 (for example, sight, hearing, touch, etc.) In the present embodiment, as the output device 3, a display arranged at a position which the driver can view (for example, instrumentation display, center display, heads up display, etc.) and a speaker are provided. The display displays information corresponding to a display signal output from the control device 5 (for example, text information or image information). The speaker outputs audio corresponding to an audio signal output from the control device 5.

The storage device 4 has an HDD (hard disk drive), SSD (solid state drive), nonvolatile semiconductor memory, or other storage memory and stores high definition maps. High definition maps include the various road information required for automated driving of automated driving level 3. Automated driving of automated driving level 3 is automated driving in a limited region satisfying predetermined driving environment conditions in which all dynamic driving tasks comprised of recognition, judgment, and operation are performed by the later explained control device 5.

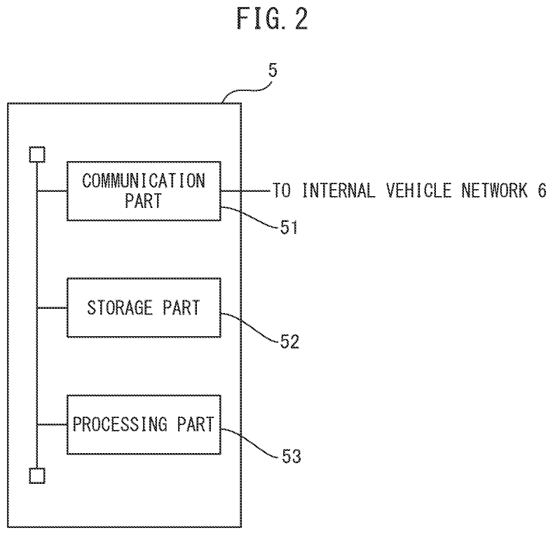

The control device 5 is an ECU (electronic control unit) provided with a communication part 51, storage part 52, and processing part 53 (see FIG. 2). The control device 5 receives as input, in addition to the above-mentioned surrounding data and driver data, various types of data required for performing automated driving of automated driving level 3 (for example, vehicle position data acquired by a position measuring sensor, vehicle speed data acquired by a vehicle speed sensor, etc.) The control device 5 comprehensively controls the operation of the vehicle 100 and performs automated driving of automated driving level 3 based on these input data and a high definition map. While automated driving of automated driving level 3 is being performed, the driver can perform a second task (for example, operating a smartphone, tilting back the seat to relax, or other task besides driving). Further, the control device 5 generates a display signal and audio signal in accordance with need and sends them to the output device 3 to provide various notifications through the output device 3 to the driver.

FIG. 2 is a view showing the hardware configuration of the control device 5.

The control device 5 is provided with a communication part 51, storage part 52, and processing part 53.

The communication part 51 is provided with an interface circuit connecting the control device 5 to the internal vehicle network 6. The communication part 51 supplies the data received from the outside (surrounding data, driver data, etc.) to the processing part 53. Further, the communication part 51 sends the display signal and audio signal output from the processing part 53 to the output device 3.

The storage part 52 has a HDD (hard disk drive) or SSD (solid state drive) or semiconductor memory or other storage medium and stores various computer programs and data etc. used for processing at the processing part 53.

The processing part 53 has one or more CPUs (central processing units) and their peripheral circuits and runs various computer programs stored in the storage part 52, for example, is a processor.

Here, as explained above, while automated driving of automated driving level 3 is being performed by the control device 5, the driver can perform a second task. On the other hand, the control device 5, for example, requests the driver through the output device 3 to take over at least part of the dynamic driving tasks if ending up driving outside of the range of the high definition map, if the surrounding sensor 1, driver sensor 2, etc. breaks down, or otherwise the predetermined driving environment conditions for automated driving of automated driving level 3 are no longer satisfied. At this time, if the driver cannot quickly take over dynamic driving tasks, safe driving of the vehicle 100 becomes difficult.

In this way, the control device 5 sometimes requests a driver to take back driving from automated driving and resume manual driving where at least part of the dynamic driving tasks are performed by the driver when performing automated driving. However, for example, a driver with little driving history, a driver not driving for a long time, etc. is not familiar with taking back driving from automated driving and resuming manual driving, so is liable to be unable to quickly take over dynamic driving tasks.

As a measure for a driver not familiar with taking back driving from automated driving and resuming manual driving, for example, causing him or her to practice taking back driving from automated driving and resuming manual driving when performing automated driving may be mentioned. At this time, for example, one proposal would be to practice taking back driving in an environment in which practice would be relatively easy such as a driving scene of driving at a fixed speed in a situation in which there are no other vehicles present in the surroundings of the vehicle 100, but in actuality, requests for taking back driving from automated driving and resuming manual driving are not limited to a driving scene of driving at a fixed speed in a situation in which there are no other vehicles present in the surroundings of the vehicle 100. For example, there is a possibility of requests being made in various driving scenes in automated driving such as a driving scene in which the vehicle 100 is running at a fixed speed in a situation where another vehicle is present in the surroundings of the vehicle 100, a driving scene in which the vehicle 100 is coming up on the tail end of congestion and has to decelerate, a driving scene where there is another vehicle driving at a low speed at the front and the vehicle 100 has to change lanes, etc. Further, at the time of taking back driving from automated driving and resuming manual driving, the safety check operations and driving operations sought from the driver differ for each driving scene.

Therefore, it can be said to be preferable to make the driver practice taking back driving from automated driving and resume manual driving for every driving scene. However, in this way, it is expected that driving scenes in which taking back driving is familiar with and driving scenes in which taking back driving is not familiar with would arise. In such a case, if the frequency of practicing taking back driving in driving scenes in which taking back driving is familiar with is not lowered, the driver is liable to feel bothered by practicing taking back driving. On the other hand, if the frequency of practicing taking back driving in driving scenes in which taking back driving is familiar with is not raised, when a request is actually made for taking back driving from automated driving and resuming manual driving at the driving scene, it is liable to be impossible to quickly take over the dynamic driving tasks.

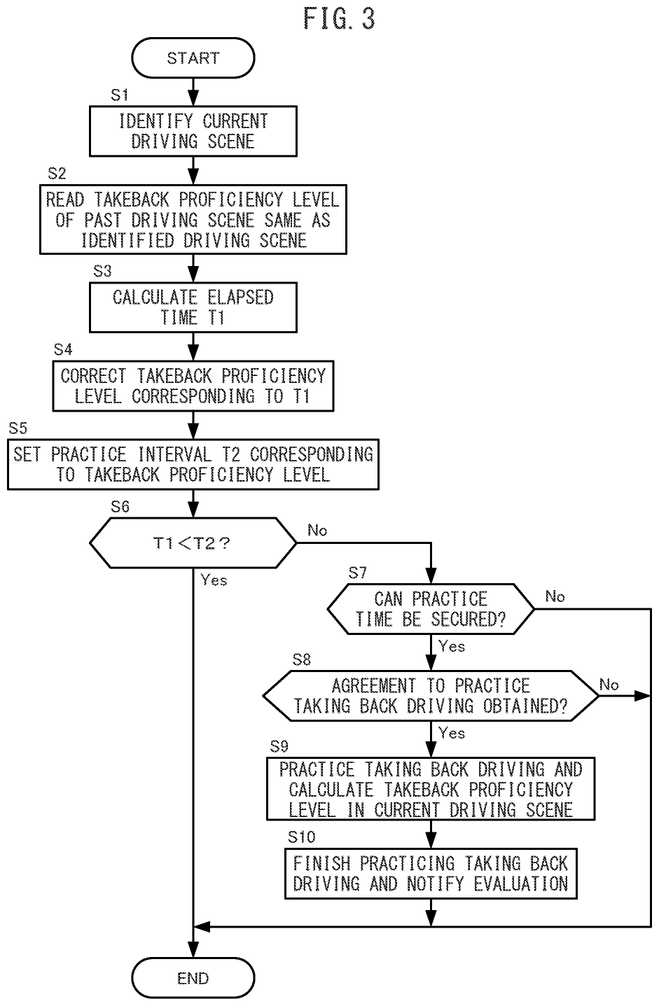

Therefore, in the present embodiment, it is made possible to make a driver practice taking back driving by a suitable frequency for every driving scene. Below, referring to FIG. 3, details of processing for practicing taking back for making a driver practice taking back driving from automated driving and resuming manual driving will be explained.

FIG. 3 is a flow chart for explaining details of processing for practicing taking back driving according to the first embodiment of the present invention. The present processing is performed at the processing part 53 of the control device 5.

At step S1, the control device 5 identifies the current driving scene of the vehicle 100 based on surrounding data received from the surrounding sensor 1, specifically the surrounding images received from the external camera. In the present embodiment, the control device 5 successively inputs surrounding images received from the external camera into a classifier and detects the number of objects present at the surroundings of the vehicle 100, the types of the objects (passenger cars or trucks, two-wheeled vehicles, pedestrians, etc.), the positional relationship with the objects (the positions of objects with respect to the vehicle 100), the presence of branching or merging or other road configurations, the weather, etc. in time series so as to identify the driving scene of the vehicle 100. The classifier, for example, can be made a convolutional neural network (CNN) having a plurality of convolution layers connected in series from the input side to the output side. Note that, in identifying the driving scene, for example, road traffic information, weather information, and other various types of information received from outside information centers may be referred to.

Due to the processing of step S1, for example, it is identified if the current driving scene is a scene in which another vehicle or other object is present in the surrounding of the vehicle 100, what kind of weather the weather is (clear, raining, snowing, strong winds, etc.), if the scene is of constant speed driving, if the scene is of acceleration or deceleration, if the scene is of the need for a lane change, etc.

At step S2, the control device 5 reads a level of proficiency of taking back driving calculated (below, referred to as the “takeback proficiency level”) when practicing taking back driving while driving in the past on a driving scene the same as the present and stored in the storage part 52, that is, the takeback proficiency level calculated when last practicing taking back driving at the same driving scene as the present. Details of the takeback proficiency level will be explained later, but the takeback proficiency level is a numerical representation for each driving scene of whether a driver is familiar with or not familiar with taking back driving in accordance with the time required for taking back driving and action of the driver when taking back driving. Note that the control device 5 makes the takeback proficiency level the minimum value (for example, zero) if not practicing taking back driving at the same driving scene as the present in the past.

At step S3, the control device 5 calculates the elapsed time T1 from when last practicing taking back driving at the same driving scene as the present.

At step S4, the control device 5 corrects the takeback proficiency level based on the elapsed time T1. In the present embodiment, if the elapsed time T1 is greater than or equal to the predetermined time, the control device 5 corrects the takeback proficiency level so that the takeback proficiency level becomes lower gradually or in stages the greater the elapsed time T1. This is because it is believed that the longer the elapsed time T1 from last practicing taking back driving, the state not familiar with taking back driving from automated driving is returned to. Note that this step S4 may be omitted.

At step S5, the control device 5 sets a target value T2 of the interval of practicing taking back driving (below, referred to as a “practice interval”) based on the takeback proficiency level. The practice interval T2 basically is made longer when the takeback proficiency level is high compared to when it is low. Due to this, when takeback proficiency level is high, that is, when it is possible to judge that the driver is familiar with taking back driving at the current driving scene, it is possible to lengthen the practice interval T2 to lower the frequency of practicing taking back driving.

At step S6, the control device 5 judges whether the elapsed time T1 from when last practicing taking back driving is less than the practice interval T2. If the elapsed time T1 is less than the practice interval T2, the control device 5 judges that it is still not necessary to practice taking back driving and ends the current processing. On the other hand, if the elapsed time T1 is greater than or equal to the practice interval T2, the control device 5 judges that taking back driving has to be practiced and proceeds to the processing of step S7.

At step S7, the control device 5 judges whether it is possible to secure practice time for practicing taking back driving. In the present embodiment, if the current point of time is a point of time of greater than or equal to a predetermined time before a projected end point of time of the automated driving, the control device 5 judges that the practice time for practicing taking back driving can be secured and proceeds to the processing of step S8. On the other hand, if not a point of time of greater than equal to a predetermined time before the projected end point of time of the automated driving, the control device 5 judges that the practice time for practicing taking back driving cannot be secured and ends the current processing.

At step S8, the control device 5 inquires through the output device 3 with the driver whether he or she can practice taking back driving. If agreement is obtained over practicing taking back driving, the routine proceeds to the processing of step S9. On the other hand, the control device 5 ends the current processing if agreement is not obtained over practicing taking back driving.

At step S9, the control device 5 makes the driver practice taking back driving. Further, the control device 5 calculate the takeback proficiency level in the current driving scene based on one or both of the time required until taking back driving and actions of the driver in the period of taking back driving and stores the calculated takeback proficiency level linked with the current driving scene in the storage part 52.

In the present embodiment, the control device 5 raises the takeback proficiency level when the time required until taking back driving is short compared to when it is long. This is because the shorter the time required until taking back driving, it more possible it is to judge familiarity with taking back driving.

Further, the control device 5 compares actions in the period of taking back driving against evaluation items set for each driving scene and raises the takeback proficiency level when there are many actions of the driver matching the evaluation items compared with when there are few.

As evaluation items, for example, the presence of any of various safety check operations in the period for taking back driving and the timings of performance of the same may be mentioned. These evaluation items can be evaluated by, for example, detecting whether checks of a room mirror or checks of side mirrors, visual checks of blind angle parts, and other of various types of safety check operations demanded for each driving scene have been performed at suitable timings before starting driving operations (steering wheel operation, accelerator pedal operation, or brake operation) based on actions of the driver.

Further, as evaluation items, for example, suitable driving operations in the period for taking back driving can be mentioned. These evaluation items can be evaluated by, for example, detecting whether the amounts of operation of the driving operations in the period for taking back driving exceed allowable amounts preset for each driving scene.

Note that, an action of the driver can be detected based on driver data received from the driver sensor 2, specifically external images of the driver received from the driver monitor camera. In the present embodiment, the control device 5 successively inputs external images of the driver received from the driver monitor camera to a classifier and detects the positions of predetermined parts of the driver such as the hands and head, the facial orientation of the driver, the state of the driver's seat, and the types and positions of objects present in the surroundings of the driver's seat in a time series to detect the actions of the driver. The classifier can, for example, be made a convolutional neural network (CNN) having a plurality of convolution layers connected in series from the input side to the output side.

At step S10, the control device 5 notifies the end of practicing switching driving to the driver through the output device 3 and notifies the evaluation of practicing switching driving to the driver. The evaluation of the practicing taking back driving notified to the driver can be simply made the takeback proficiency level. Further, for example, if as a result of the practicing taking back driving, it was not possible to take back driving within a predetermined time, various advice may be given such as informing the driver that one means of solution would be to request the control device 5 side to perform an MRM (minimal risk maneuver) for making the vehicle safely stop when taking back driving has been requested.

The control device 5 of the vehicle 100 according to the embodiment explained above is configured to perform automated driving for automatically performing driving operations of the vehicle 100, during automated driving, make a driver practice taking back driving from automated driving and resuming manual driving, where at least part of the driving tasks are performed by the driver, and calculate the takeback proficiency level (proficiency level of taking back driving) based on one or both of a time period required for taking back driving when practicing taking back driving and action of the driver in the period for taking back driving, identify a current driving scene based on surrounding data showing a state of the surroundings of the vehicle, and practice taking back driving by a frequency in accordance with the takeback proficiency level calculated when last practicing taking back driving in the same driving scene as the present.

Due to this, it is possible to make a driver practice taking back driving by a suitable frequency corresponding to the takeback proficiency level at each driving scene for each driving scene.

In more detail, the control device 5 is configured to set the practice interval T2 based on the takeback proficiency level calculated when last practicing taking back driving in the same driving scene as the present so as to reduce the frequency of practicing taking back driving when the takeback proficiency level is high compared to when it is low and to practice taking back driving if the elapsed time T1 from when last practicing taking back driving in the same driving scene as the present is greater than or equal to the practice interval T2 and lengthen the practice interval T2 when the takeback proficiency level is high compared to when it is low.

For this reason, it is possible to lower the frequency of practicing taking back driving at a driving scene familiar with taking back driving, so it is possible to keep a driver from feeling bothered by practicing taking back driving. Further, it is possible to raise the frequency of practicing taking back driving in a driving scene in which the driver is not familiar with taking back driving, so it becomes possible to quickly take over dynamic driving tasks when a request for taking back driving from automated driving to manual driving is actually made in that driving scene.

Further, the control device 5 according to the present embodiment is configured to make corrections for lowering the takeback proficiency level based on the elapsed time T1 from when last practicing taking back driving in the same driving scene as the present to increase the amount of reduction by correction gradually or in stages the longer the elapsed time T1.

Due to this, it is possible to set the takeback proficiency level taking into consideration returning to a state not familiar with taking back driving from automated driving and resuming manual driving due to it becoming forgotten along with the elapse of time, so it is possible to make a driver practice taking back driving by a more suitable frequency.

Further, the control device 5 according to the present embodiment is configured so as to compare actions of the driver in the period for taking back driving against evaluation items set for each driving scene and raise the takeback proficiency level when there are many actions matching evaluation items compared to when there are few. The evaluation items include any performance of safety check operations preset for each driving scene and the timing of performance. Further, the evaluation items include the amount of operation in driving operations in the period for taking back driving not exceeding the allowable amounts preset for each driving scene.

Due to this, it is possible to obtain a more accurate grasp of the takeback proficiency level of a driver.

Further, the control device 5 according to the present embodiment is configured so as to notify a driver of an evaluation of practicing taking back driving through an output device 3 for making notifications to the driver of the vehicle 100 when finishing practicing taking back driving.

Due to this, it is possible to feed back the evaluation of practicing taking back driving to the driver and improve the motion of the driver at the time of taking back driving.

### Second Embodiment

Next, a second embodiment of the present invention will be explained. The present embodiment differs from the first embodiment on the point of judging whether the driver is practicing taking back driving based on the state of the driver. Below, the embodiment will be explained focusing on the point of difference.

As explained above, while automated driving of automated driving level 3 is being performed by the control device 5, the driver can perform a second task. However, for example, when a driver with little driving history, a driver not driving for a long time, etc. is performing a certain second task, it is liable to be impossible to obtain a grasp of what extent of time would be required for shifting from the state of performing the second task to taking back driving and what kind of operation (for example, operation to change seat position, safety check operations, etc.) would be necessary.

Therefore, in the present embodiment, it is made possible to make a driver practice taking back driving by a suitable frequency for each second task being performed by the driver.

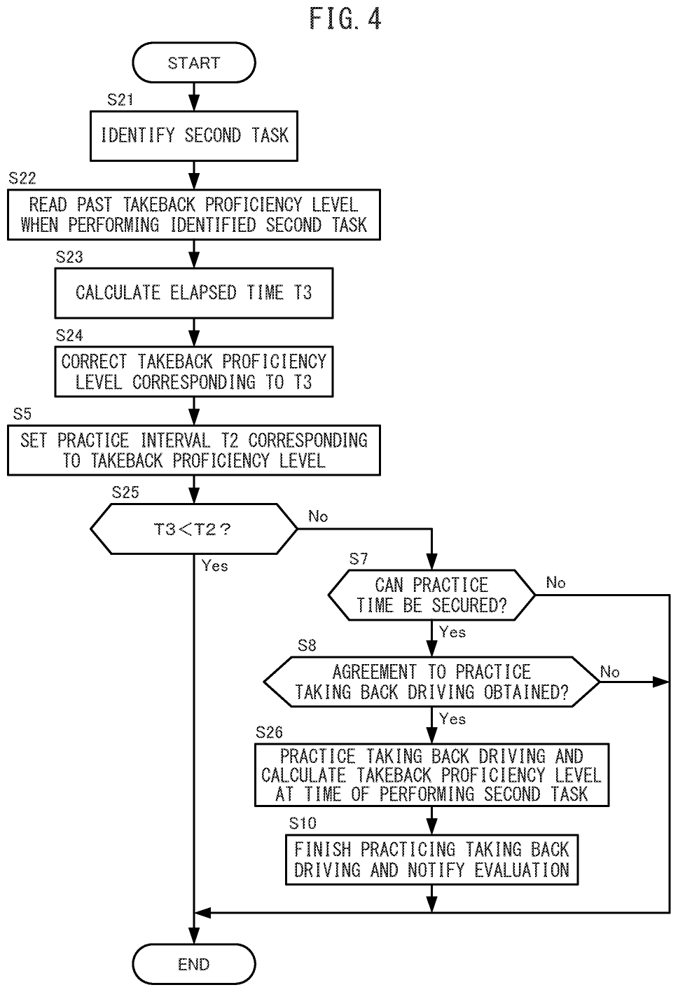

FIG. 4 is a flow chart for explaining details of processing for practicing taking back driving according to the present embodiment. The present processing is performed by a predetermined processing cycle in the processing part 53 of the control device 5. Note that, in the flow chart of FIG. 4, the contents of the processing of steps S5, S7, S8, and S10 are similar to the first embodiment, so explanations will be omitted here.

At step S21, the control device 5 identifies the second task which the driver is performing (for example, operating a smartphone, reading a book, watching a movie, tilting back the seat to relax, etc.) based on the driver data received from the driver sensor 2, more specifically an external image of the driver received from the driver monitor camera. In the present embodiment, the control device 5 successively inputs external images of the driver received from the driver monitor camera to a classifier and detects the positions of predetermined parts of the driver such as the hands and head, the facial orientation of the driver, the state of the driver's seat, and the types and positions of objects present in the surroundings of the driver's seat in a time series, to detect the second task being performed by the driver. The classifier can, for example, be made a convolutional neural network (CNN) having a plurality of convolution layers connected in series from the input side to the output side. Note that, identification of the second task being performed by the driver is not limited to the above method. It may be identified various known methods.

At step S22, the control device 5 reads the takeback proficiency level calculated at the time of most recently practicing taking back driving when performing a second task the same as the present and stored in the storage part 52.

At step S23, the control device 5 calculates the elapsed time T3 from most recently practicing taking back driving performed when performing the same second task as the present.

At step S24, the control device 5 corrects the takeback proficiency level based on the elapsed time T3. In the present embodiment, the control device 5 corrects the takeback proficiency level so that the takeback proficiency level becomes lower the greater the elapsed time T3 if the elapsed time T3 is greater than or equal to a predetermined time. Note that in the same way as the first embodiment, this step S24 may be omitted.

At step S26, the control device 5 judges whether the elapsed time T3 is less than the practice interval T2. If the elapsed time T3 is less than the practice interval T2, the control device 5 judges that taking back driving has still not been practiced and ends the current processing. On the other hand, if the elapsed time T3 is greater than or equal to the practice interval T2, the control device 5 judges that there is a need to practice taking back driving and proceeds to the processing of step S7.

At step S26, the control device 5 makes the driver practice taking back driving. Further, the control device 5 calculates the takeback proficiency level at the time of performing the second task based on one or both of a time period required for taking back driving and the action of the driver at the time of taking back driving. It stores this in the storage part 52 linked with the second task for which the calculated takeback proficiency level was performed.

The control device 5 of the vehicle 100 according to the embodiment explained above is configured to identify the second task which the driver is performing in automated driving based on driver data showing the state of the driver and make the driver practice taking back driving by a frequency according to the takeback proficiency level calculated at the time of most recently practicing taking back driving when performing a second task the same as the present.

In more detail, the control device 5 is configured to set the practice interval T2 based on the takeback proficiency level calculated at the time of most recently practicing taking back driving when performing a second task the same as the present so that it is possible to reduce the frequency of practicing taking back driving when the takeback proficiency level is high compared with when it is low and to make the driver practice taking back driving if the elapsed time T3 from most recently practicing taking back driving when performing a second task the same as the present is greater than or equal to the practice interval T2.

Due to this, it is possible to make a driver practice taking back driving by a suitable frequency for each second task performed by the driver.

Above, embodiments of the present invention were explained, but the embodiments only show some of the examples of application of the present invention and are not intended to limit the technical scope of the present invention to the specific constitutions of the embodiments.

For example, in the above second embodiment, a second task performed by the driver was identified from the external image of the driver, but taking back driving may be made to be practiced, for example, when it is possible to detect the degree of alertness of the driver from an external image of the driver and judge that the degree of alertness falls to less than or equal to a certain level. Due to this, it is possible to keep the degree of alertness of the driver from falling to less than or equal to a certain level.

Further, for example, in the above embodiments, when a clearly dangerous unintended mistaken operation is detected while practicing taking back driving, it is also possible to suspend practicing taking back driving and return to automated driving and to inform that fact to the driver.

Further, the above embodiments can be suitably combined. Therefore, the processings for practicing taking back driving explained in the first embodiment and second embodiment driving are made to be performed in parallel.

Further, in the above embodiments, the computer program run in the control device 5 (processing for practicing taking back driving) may be provided in a form recorded in a computer readable portable recording medium (nontransitory computer recording medium) such as a semiconductor memory, magnetic recording medium, or optical recording medium.

1. A control device for a vehicle, wherein
the control device is configured to:
perform automated driving for automatically performing driving operations of the vehicle;
make a driver practice taking back driving from automated driving and resuming manual driving, where at least part of the driving tasks are performed by the driver, during automated driving and calculate a proficiency level of taking back driving based on one or both of a time period required for taking back driving when practicing taking back driving and action of the driver in the period for taking back driving;
identify a current driving scene based on surrounding data showing a state of the surroundings of the vehicle; and
practice taking back driving by a frequency in accordance with the proficiency level calculated when last practicing taking back driving in the same driving scene as the present.

2. The control device for a vehicle according to claim 1, wherein
the control device is configured to reduce the frequency when the proficiency level is high compared to when it is low.

3. The control device for a vehicle according to claim 1, wherein
the control device is configured to:
set a practice interval based on the proficiency level calculated when last practicing taking back driving at the same driving scene as the present; and
practice taking back driving if an elapsed time from when last practicing taking back driving at the same driving scene as the present is greater than or equal to the practice interval.

4. The control device for a vehicle according to claim 3, wherein
the control device is configured to lengthen the practice interval when the proficiency level is high compared to when it is low.

5. The control device for a vehicle according to claim 1, wherein
the control device is configured to:
perform correction so as to lower the proficiency level based on the elapsed time from when last practicing taking back driving at the same driving scene as the present; and
increase an amount of correction gradually or in stages as the elapsed time becomes longer.

6. The control device for a vehicle according to claim 1, wherein
the control device is configured to raise the proficiency level when the time period required for taking back driving is short compared to when it is long.

7. The control device for a vehicle according to claim 1, wherein
the control device is configured to compare actions of the driver in the period for taking back driving with evaluation items set for each driving scene and raise the proficiency level when there are many actions which match the evaluation items compared with when there are few.

8. The control device for a vehicle according to claim 7, wherein the evaluation items include any presence of safety check operations set in advance for each driving scene and timing of performance.

9. The control device for a vehicle according to claim 7, wherein evaluation items include an amount of operation in a driving operation in the period for taking back driving not exceeding the allowable amount set in advance for each driving scene.

10. The control device for a vehicle according to claim 1, wherein
the control device is configured to:
identify a second task which the driver is performing during automated driving based on driver data showing the state of the driver; and
separately practice taking back driving by a frequency corresponding to the proficiency level calculated at the time of most recently practicing taking back driving when performing the same second task as the present.

11. The control device for a vehicle according to claim 10, wherein
the control device is configured to:
set the practice interval based on the proficiency level calculated at the time of most recently practicing taking back driving when performing the same second task as the present; and
separately practice taking back driving if the elapsed time from most recently practicing taking back driving when performing the same second task as the present is greater than or equal to the practice interval.

12. The control device for a vehicle according to claim 1, wherein
the control device is configured to notify the driver of an evaluation of practicing taking back driving through an output device making notifications to the driver of the vehicle when finishing practicing taking back driving.

13. A vehicle control method by a control device, wherein the vehicle control method comprises:
performing automated driving for automatically performing driving operations of the vehicle;
making a driver practice taking back driving from automated driving and resuming manual driving, where at least part of the driving tasks are performed by the driver, during automated driving and calculating a proficiency level of taking back driving based on one or both of a time period required for taking back driving when practicing taking back driving and action of the driver in the period for taking back driving;
identifying a current driving scene based on surrounding data showing a state of the surroundings of the vehicle; and
practicing taking back driving by a frequency in accordance with the proficiency level calculated when last practicing taking back driving in the same driving scene as the present.

14. A nontransitory computer recording medium including a computer program for a control device for a vehicle,
the nontransitory computer recording medium including a computer program for making the control device:
perform automated driving for automatically performing driving operations of the vehicle;
during automated driving, make a driver practice taking back driving from automated driving and resuming manual driving, where at least part of the driving tasks are performed by the driver, and calculate a proficiency level of taking back driving based on one or both of a time period required for taking back driving when practicing taking back driving and action of the driver in the period for taking back driving;
identify a current driving scene based on surrounding data showing a state of the surroundings of the vehicle; and
practice taking back driving by a frequency in accordance with the proficiency level calculated when last practicing taking back driving in the same driving scene as the present.
